(19) United States
(12) Patent Application Publication
(10) Pub. No.: US 2009/0236453 A1
(43) Pub. Date: Sep. 24, 2009

(54) Drive Mechanism

(75) Inventors: John Montgomery Heng, Palmerston North (NZ); Stefanie Elisabeth Sinn, Whangarei (NZ)

Correspondence Address: Blakely, Sokoloff, Taylor & Zafman, 1279 Oakmead Parkway, Sunnyvale, CA, 94085-4040, US

(73) Assignee: CLICK CLACK LIMITED, Paslmerston (NZ)

(21) Appl. No.: 11/885,088

(22) PCT Filed: Feb. 24, 2006
(86) PCT No.: PCT/NZ2006/000028

§ 371 Date: Aug. 21, 2007

(30) Foreign Application Priority Data
Feb. 25, 2005 (NZ) 538485

(51) Int. Cl. A47J 42/34; F16H 55/18; A47J 42/46

(52) U.S. Cl. 241/168; 74/409

(57) ABSTRACT

A drive mechanism particularly suited for use in a manual grinder for the grinding of edible grindable product. The drive mechanism includes a toothed ring 15 is engaged with a toothed rack 21. A split sleeve 16 is located within the toothed gear 15 and a shaft 14 is engaged in the bore of the split sleeve 16. The split sleeve 16 is coupled (38, 40) to the toothed gear 15 such that relative movement between the split sleeve 16 and the gear 15 can occur when the rack is moved in a first position. This movement in the first direction results in contraction of the bore of the split sleeve 16 so as to create a driving contact between the split sleeve and the shaft. Upon the rack being moved in the second direction the driving contact is removed whereby the split sleeve and toothed gear 15 can move independent of the shaft 14.

### BACKGROUND TO THE INVENTION

This invention relates to a drive mechanism. The drive mechanism is particularly useful in a manual grinder for peppercorns, salt crystals and other edible grindable product.

In our New Zealand patent specification 528182 there is described and claimed an easy-to-use manual grinder for peppercorns, salt crystals and other edible grindable products. The manual grinder, as described in NZ 528182, is a manual grinder that can be held in one hand and operated. This is principally achieved by the manual grinder having an operating lever which is hinged and, therefore, can be operated on a squeeze and release type operation. The lever is described as controlling a linearly moveable toothed element (e.g. rack) which engages with a toothed wheel on a drive shaft. The mechanism thereby translates a linear movement into a rotary movement which is imparted to the grinding elements.

Another example of a manual grinder with a rack and pinion type drive mechanism can be found in U.S. patent specification

With such drive mechanisms a problem arises from the lost motion inherent in the mechanism. This primarily is due to backlash clearance of the teeth in a ratchet which is included in the drive mechanism so that upon release of the control lever the shaft is not rotated in a reverse direction.

The lost motion means, in practical terms, that the maximum amount of rotation of the grinding elements for each stroke of the mechanism is not achieved. Hence the grinding effect is inefficient. For example, many operations of the operating lever will be necessary to effect the required grind of material. This can be frustrating to the end user and for those who may lack hand span or strength it could, in extreme cases, result in the grinder not being useable by the end user.

### SUMMARY OF THE INVENTION

An object of the present invention is to provide a linear to rotary drive mechanism which can be incorporated in a product such as a manual grinder to provide a positive non-reversible drive or, at least, to provide the public with a useful choice.

According to one broad aspect of the invention there is provided a drive mechanism including a first toothed element, a second toothed element engaged with the first toothed element, the second toothed element being movable in a first direction to cause movement of the first toothed element and in the second direction to cause reverse movement of the first toothed element, a split sleeve into a bore of which a shaft can be engaged, the split sleeve is coupled to the first toothed element such that relative movement between the split sleeve and first toothed element can occur when the rack is moved in said first direction where, upon engagement, contraction of the bore creates a driving contact between the split sleeve and shaft, and said movement of the second toothed element in the second direction is in the absence of the driving contact whereby the split sleeve and first toothed element can move independent of the shaft.

In the preferred form of the invention the second toothed element is a linear toothed element such as a rack. Preferably the first toothed element is an annular gear element with at least part of the split sleeve located within the annular gear element.

In the preferred form of the invention the split sleeve is pivotally coupled to the gear element. Preferably abutment surfaces limit the amount of movement of the split sleeve relative to the gear element.

In the preferred form of the invention a pivot pin, which creates the pivot coupling of the split sleeve to the gear element, has an axis of rotation which is offset to the axis of the bore.

In a preferred form of the invention bias means is provided to bias the split sleeve toward engagement of the abutment surfaces.

According to a second broad aspect of the present invention there is provided a manual grinder for the grinding of edible grindable product, the grinder including a body into which grindable product can be located for grinding by grinding elements located at an outlet end of the body, a shaft rotatably located within the body, an operating member located externally of the body, a drive mechanism according to the first broad aspect of the invention, and coupling means whereby the operating handle is coupled to the second tooth element of the drive mechanism whereby movement of the operating handle will cause the second toothed element to move in the first direction and thereby cause operation of the grinding elements, there being biasing means for causing the second toothed element to move in the second direction.

In a preferred form of the invention the grinder further includes friction creating means which acts on the shaft when the second toothed element moves in the second direction to thereby prevent any contact between the split sleeve and the shaft causing rotation of the shaft.

In the preferred form of the invention the operating handle is a lever pivotally coupled to the body.

### BRIEF DESCRIPTION OF THE DRAWINGS

In the following more detailed description of the drive mechanism of the invention according to a preferred form, reference will be made to the accompanying drawings in which:

FIG. 1 is a cross-sectional illustration through the centre of the drive shaft of a manual grinder incorporating the drive mechanism,

FIG. 2 is a view similar to FIG. 1 but showing the operating handle at the end of its stroke,

FIG. 3 is an exploded view of the manual grinder of FIGS. 1 and 2,

FIG. 4 is a more detailed cross-section of the top part of the manual grinder of FIGS. 1 to 3,

FIG. 5 is a perspective view illustrating a part assembly of the drive mechanism according to the present invention incorporated in a manual grinder of the type describe in our New Zealand patent specification 528182 with the operating handle in the “open” or rest position,

FIG. 6 is a similar view but with part of the mechanism removed in the interests of clarity,

FIG. 7 is a view similar to FIG. 6 but with the operating handle at the other end in its movement (i.e. the “closed” or compressed position),

FIG. 8 is a view similar to FIG. 7 but with the portion of the drive mechanism removed from FIG. 7 now shown,

FIG. 9 is a perspective view of the drive wheel and split sleeve elements of the drive mechanism according to the present invention,

FIG. 10 is a planned view of the arrangement shown in FIG. 9,

FIG. 11 is a perspective view of the drive ring and split sleeve separately,

FIG. 12 is a perspective view of the split sleeve with the pivot pin and spring shown in place,

FIG. 13 is a plan view similar to FIG. 10 showing the split sleeve in the driving contact position,

FIG. 14 is a view similar to FIG. 13 but showing the split sleeve in the non driving position, and

FIG. 15 is a perspective view of a shaft to which the drive mechanism can be connected.

### DESCRIPTION OF PREFERRED EMBODIMENTS OF THE INVENTION

The drive mechanism according to the present invention is suitable for use in products or devices where a linear action is required to be translated into a rotary movement with immediate effect. Thus, as stated previously, the present invention has particular application to a manual grinder especially of the type disclosed in our New Zealand patent specification 528128. Therefore, for the purposes of describing the present invention, the drive mechanism will be described in conjunction with a manual grinder of the type disclosed in NZ 528128. Therefore, the content of NZ 528128 is incorporated herein by way of specific reference.

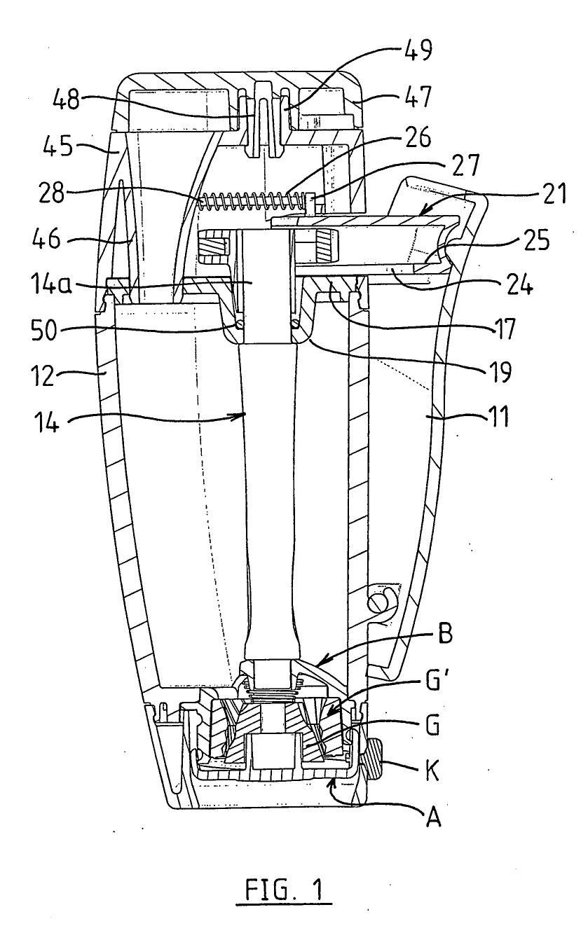

Referring to FIG. 1 there is shown a manual grinder 10 of the type shown and described in NZ 528128. As described in NZ 528128 a lever handle 11 is preferably in the form of a lever pivotally or hingedly coupled at a lower end to a body 12 of the manual grinder 10. The body 12 is hollow and located within the body 12 is a drive shaft 14. The drive shaft 14 is coupled at its lower end to a movable (rotatable) grinder element G at the outlet or lower end of the body 12. This grinder element G is located operatively within a fixed grinder element G′.

As described in NZ 528128 and our New Zealand patent specification 527450 the grinder element G is adjustable in axial position on the end of the shaft 14 and hence relative to the fixed grinder element G′ by an adjustable arrangement A. Consequently, by moving the position of the externally accessible knob K the adjuster A can be altered so as to adjust the position of the grinder element G relative to grinder G′. In this way the grind can be adjusted between fine and coarse settings.

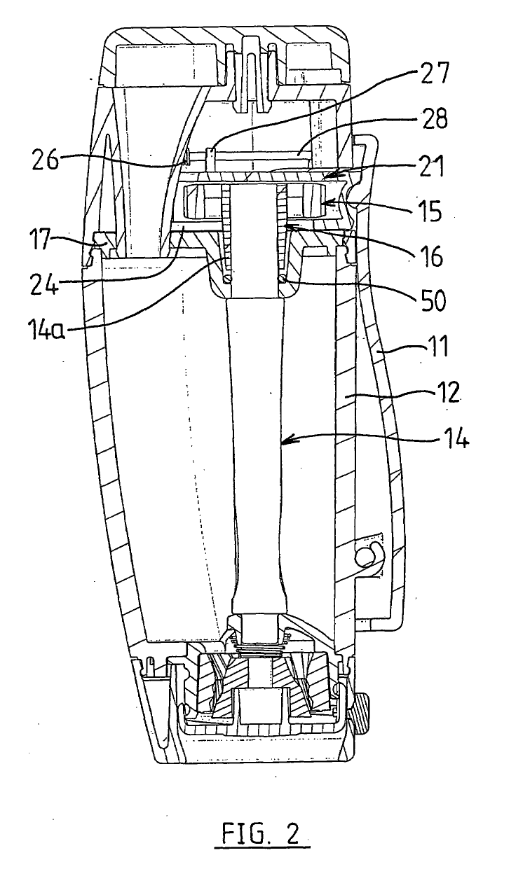

As can be seen in FIGS. 1 and 2 the shaft 14 is located in the body 12 between a lower bearing arrangement B and an upper bearing arrangement which is formed by a well 19 formed as part of (preferably integrally) with a cover 17 hereinafter described.

Accordingly, the shaft 14 is supported within the body 12 and is prevented from any appreciable longitudinal movement in the direction of the axis of rotation of the shaft 14. Consequently, the adjustment of the moveable grinder element G takes place axially independently of the shaft 14 i.e. without any axial movement of the shaft 14 being required.

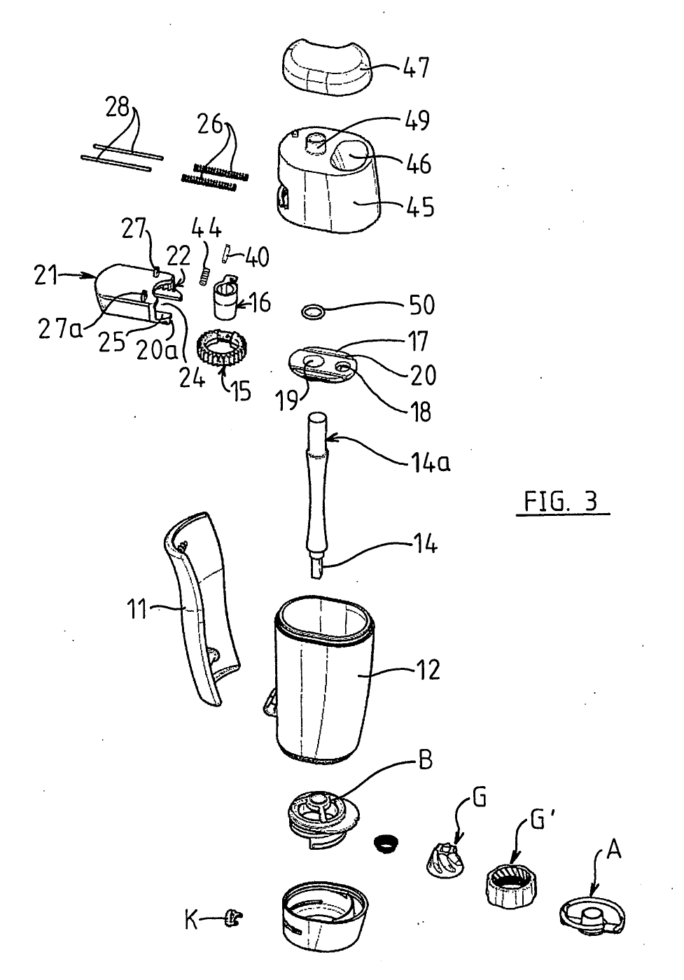

In the preferred form of the grinder the grinder element G is a 7 start ceramic element as can be seen in FIG. 3. The grinder element G′ is preferably also ceramic with a multiplicity of inclined teeth.

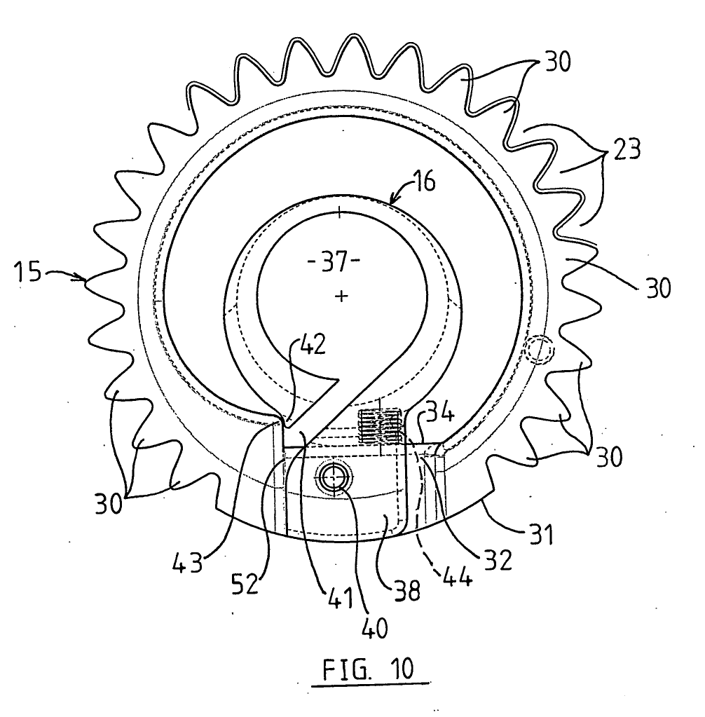

Extending transversely to the lever handle 11 is a push element 21, which incorporates a rack 22 formed by a plurality of teeth 23. The teeth 23 of rack 22 meshingly engage with the teeth of a gear element which in the preferred form of the invention is a toothed ring 15. The actual number of teeth 23, of rack 22, which engage with drive ring 15 is illustrated in FIG. 10.

The drive ring 15 and rack 22 thus form two elements of the drive mechanism according to the present invention. The third element is a split sleeve 16.

As with the arrangement disclosed in NZ 528128 the top of the body 12 is closed by a cover 17 in which is an opening 18, through which the grindable material can be loaded into the body 12. According to this particular form of the invention, the cover 17 includes a pair of spaced parallel grooves 20 into each of which a projecting portion 20a of the push element 21 is slidingly engaged.

As can be seen in FIG. 1 the push element 21 is essentially hollow. Thus, as the lever 11 is pivotally moved toward the body 12, the combination of the gear ring 15 and split sleeve 16 move into the confines of the push element 21. There is a cut away portion 24 in the floor 25 of the push element 21 so as to provide a clearance for the shaft 14.

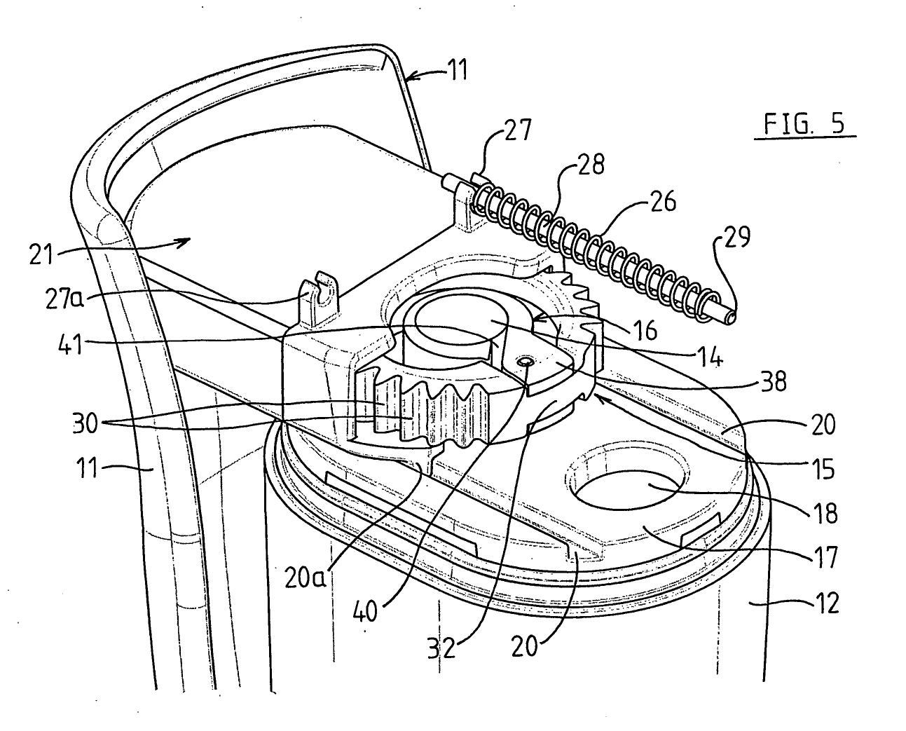

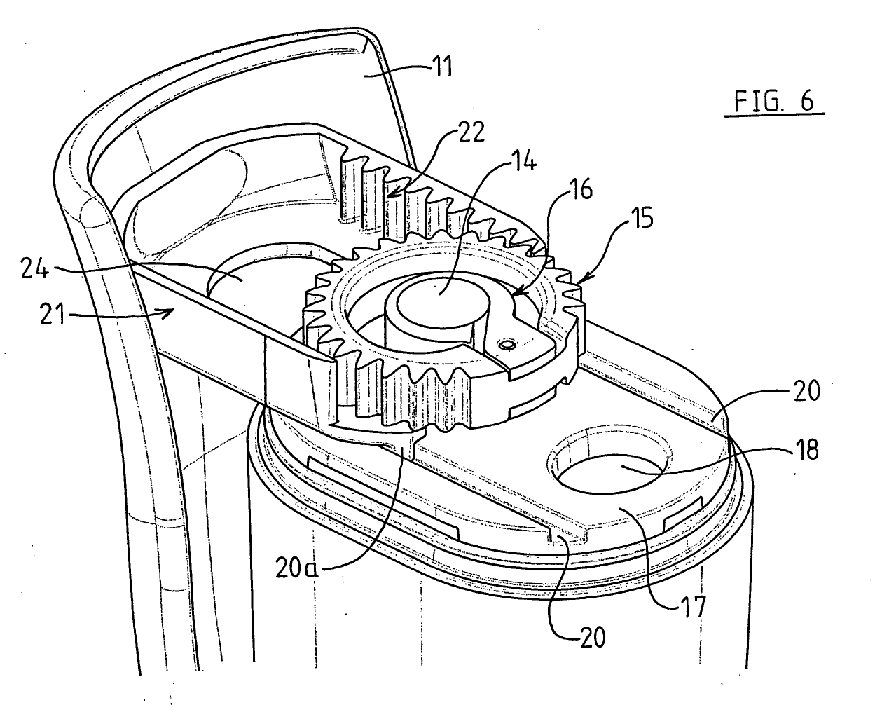

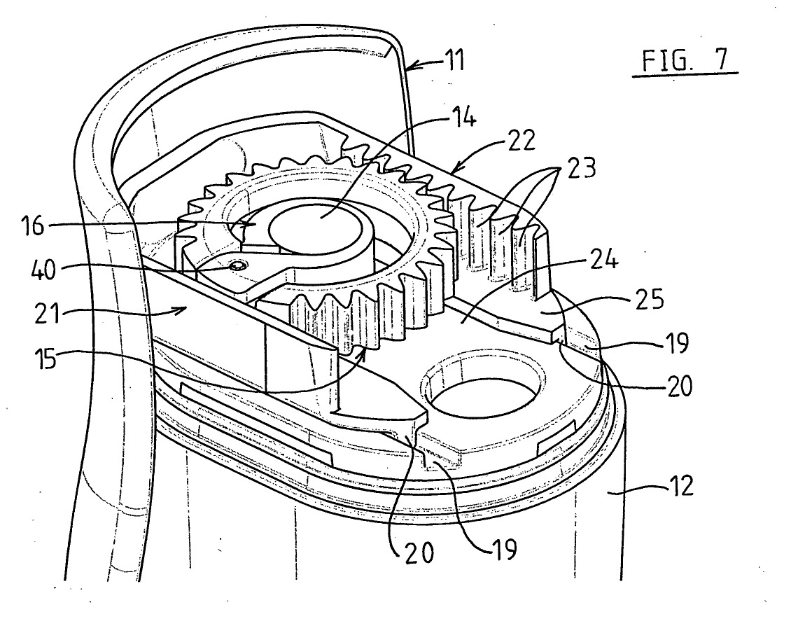

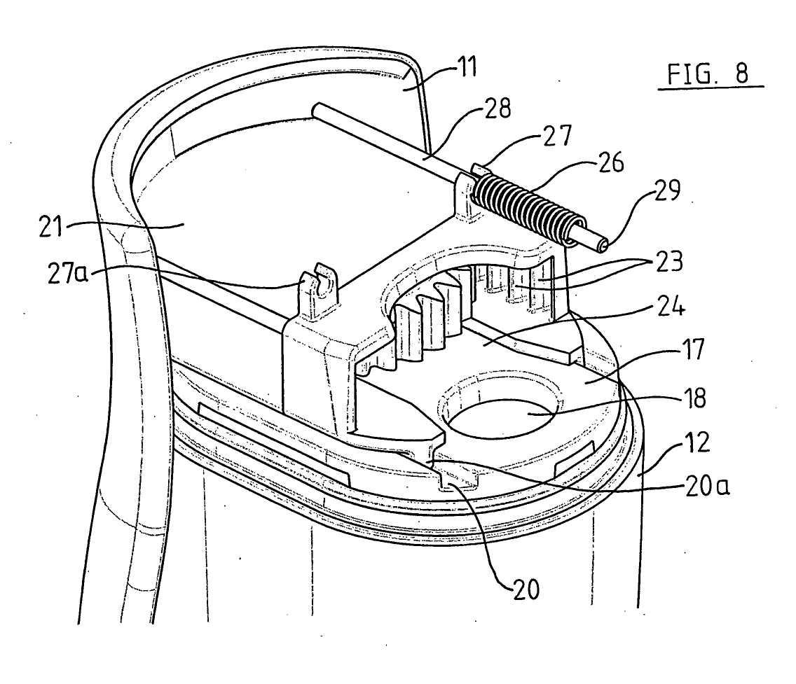

As is illustrated in FIG. 1 a spring 26 engages at one end on an abutment 27 on the upperside of the push element 21. A rod 28 engages through the spring 26 and abutment 27. End 29 of the rod 28 is engaged within the upper casing 45, which fits onto the top of the body 12 as is disclosed in NZ 528128 and shown in FIGS. 1, 2 and 4 hereof. While only one spring and rod combination is illustrated a second combination of rod and spring engages with second abutment 27a (see FIGS. 5 and 8).

Thus, as the lever 11 is moved toward the body 12 the springs 26 compress and provide a restoring force to the lever 11 upon the user releasing pressure on the lever 11 (this action is as described in NZ 528128). Thus, when a pull or “squeeze” type action is applied to the lever 11 by the end user, the toothed ring 15 rotates and, as will hereinafter described, via the split sleeve 16, applies a torque to the shaft 14 thereby rotating the shaft. However, upon the lever 11 being released the interaction of the rack 22 and the toothed ring 15 causes the ring 15 to rotate in the opposite direction. As will be described. no torque or driving force is applied to the shaft 14 during this counter rotation.

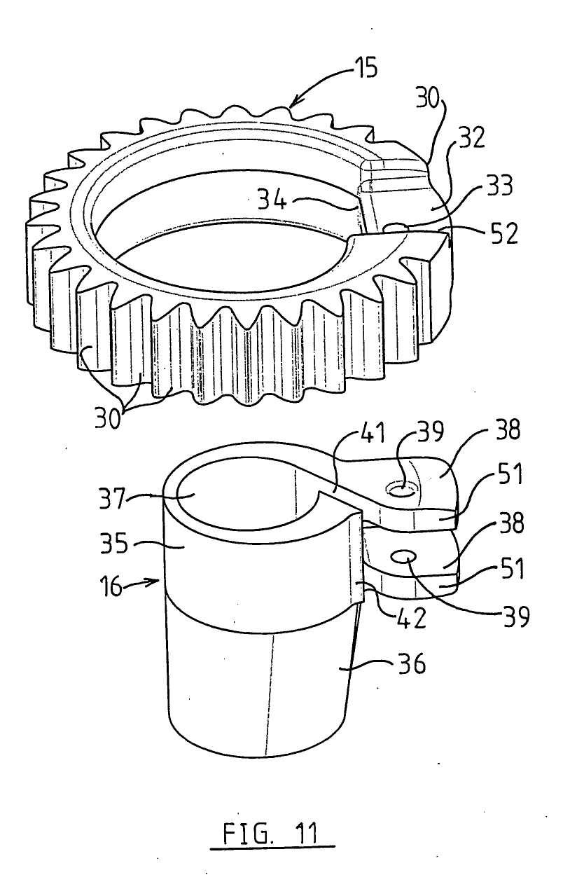

FIG. 10 of the drawings illustrates that the toothed ring 15 has about its peripheral outer edge a plurality of teeth 30, which mesh with teeth 23 of rack 22. The teeth extend about nearly all of the peripheral edge except for a non-toothed portion 31, which includes an area of reduced thickness thereby forming a web 32. An opening 33 (see FIG. 11) extends through the web 32 and is positioned closer to an inner edge surface 34 which is flat.

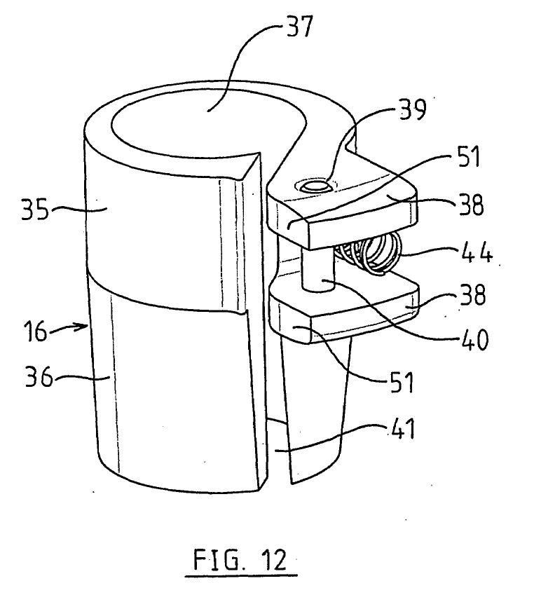

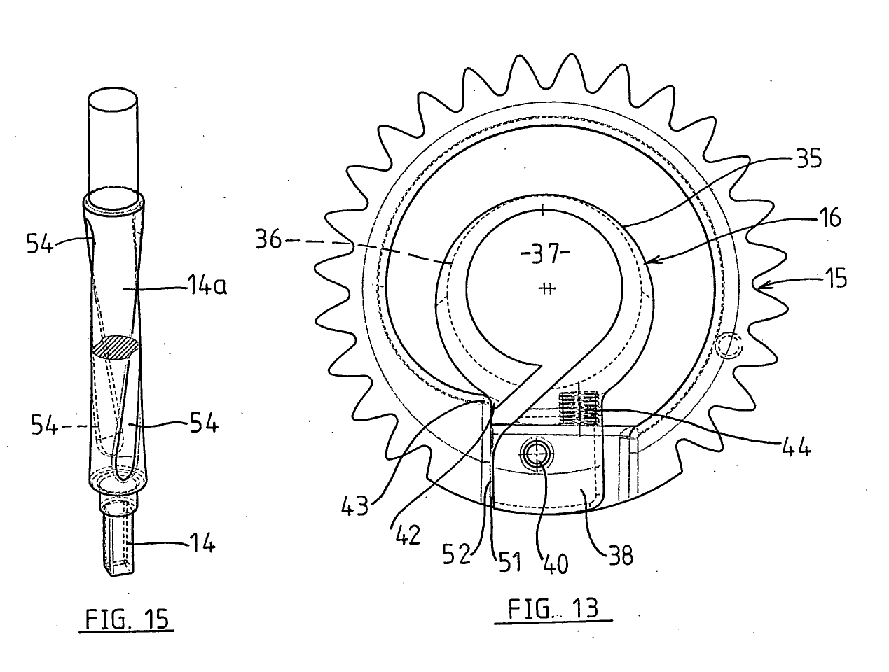

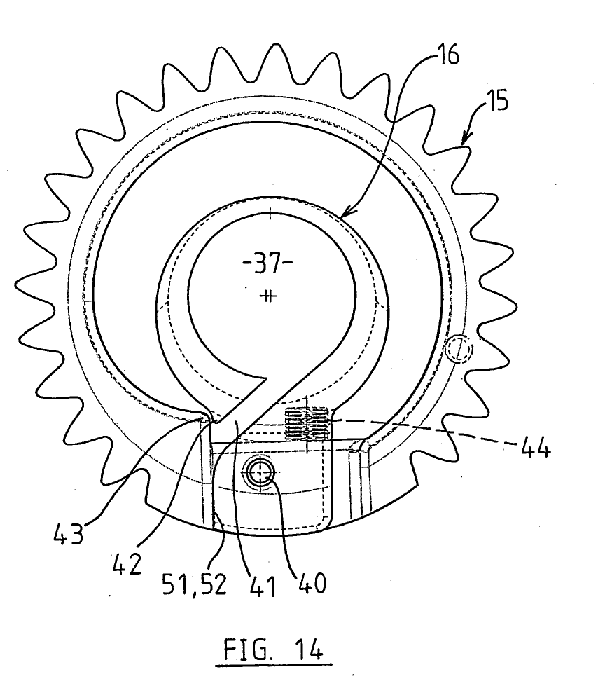

The split sleeve 16 (see FIGS. 11 and 12) has a straight-sided portion 35 and extending therebelow a frustro conical portion 36. The internal dimensions of the bore 37, which extends through the split sleeve 16, are such that when the shaft 14 is to fitted therein, there is a snug fit but yet one which permits the split-sleeve to rotate on the shaft. This will hereinafter become apparent.

In a preferred form of the invention the shaft 14 has fitted thereto a sleeve 14a of plastic material (see e.g. FIG. 15). This sleeve 14a engages in the bore 37 of split sleeve 16. Preferably the sleeve 14a is formed by over-moulding the shaft 14 with TPU/polyurethane or other material suitable for the end purpose. Equally a metal, preferably knurled, shaft could be used.

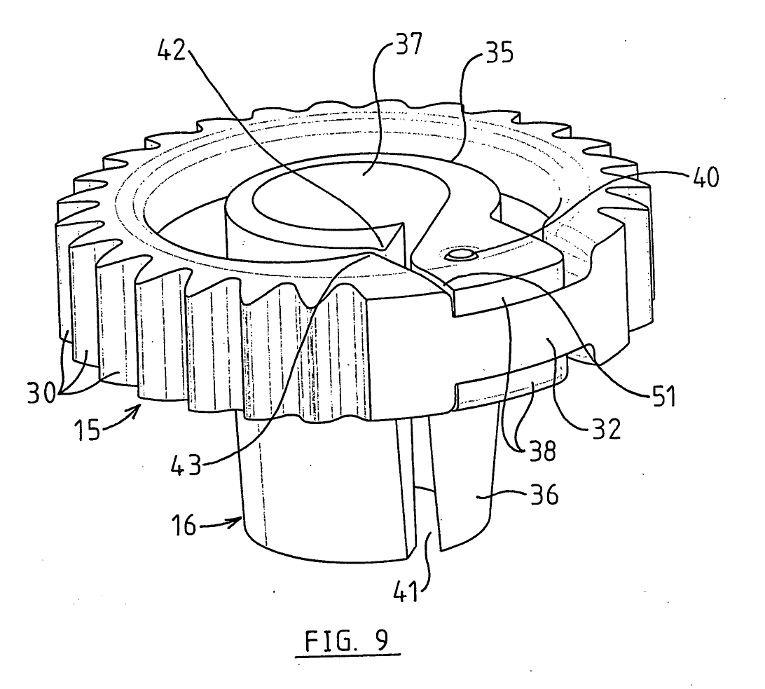

Projecting laterally of the upper portion 35 of split sleeve 16 is a pair of flanges 38. The distance between these flanges 38 is slightly more than the thickness of the web 32. These flanges 38 each have an opening 39, which are aligned. When the flanges 38 are located over the web 32 the openings 29 become aligned with hole 33 in the web 32. A pin 40 (see FIG. 9) can thus be engaged through the aligned openings 33 and 39 to capture the flanges 38 onto the web 32. The pin 40 has its axis of rotation offset to the central longitudinal axis of bore 37 of split sleeve 16.

The flanges 38 include abutments surfaces 51 (see FIG. 1-2) which are located opposite abutment surfaces 52 of the first toothed element 15. Because of the position of the pivot pin 40 and a clearance between the abutment surfaces 51 and 52, the split sleeve 16 is capable of angular displacement relative to the toothed gear element 15 about the axis of pivot 40. Thus under the influence of the spring 44 (described in hereinafter) the movement of the split sleeve 16 relative to the toothed element 15 is not restricted but the degree of movement of the split ring 16 in the reverse direction is limited by contact between the abutment surfaces 51 and 52. This reverse movement is one which will occur upon the rack 22 retracting to the rest position of the lever 11.

The split sleeve 16 is thus capable of limited angular displacement (relative to toothed ring 15) about the longitudinal axis of pin 40.

A gap 41 extends for the full length of the sleeve 16 so as to form the split in the sleeve.

In the peripheral wall surface of the upper portion 35 of split sleeve 16, and adjacent the split 41, there is a profiled portion which forms a projection 42. This, as is shown in FIG. 12, can engage with a profiled edge portion 43 of ring 15 for reasons, which will hereinafter be apparent. The edge portion 43 is formed by the inside peripheral wall of the toothed ring 15 being profiled inwardly toward the centre of the toothed ring 15.

Preferably, a spring 44 is engaged between the flanges 38 and has one end engaged in a recess (not shown) in the outer peripheral surface of the top portion 35 of the split sleeve 16. The other end of spring 44 engages against the flat surface 34 of web 32.

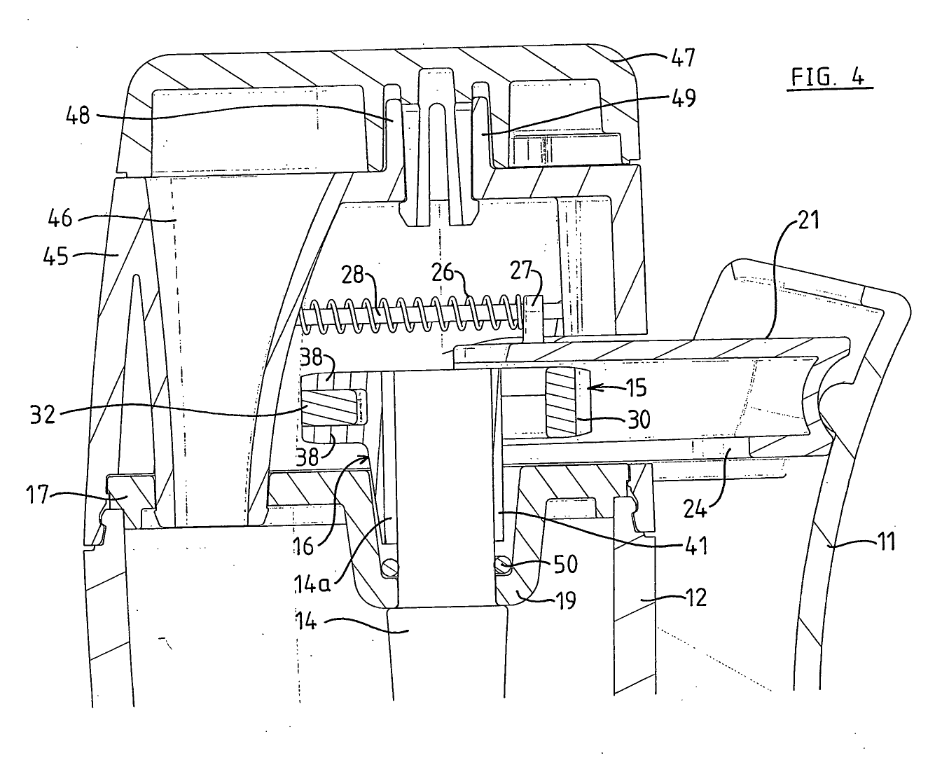

The upper casing 45, which engages onto body 12 over the cover 17, forms a housing in which the drive mechanism is located. A chute or funnel 46 extends from an open end on the top of the casing 45 to fit at a lower end in the opening 18 in the cover 17. A lid 47 covers the open top of the chute 46 but is rotatable away to uncover the open end by virtue of the cover 47 having a split stub shaft 48 which engages through an annular boss 49 which projects upwardly from the top of the upper casing 45 (see FIG. 4).

As a consequence the lid can be rotated to one side to expose the open end of the chute 46 and thereby enable the grindable material to be poured into the body 12. It will be appreciated that this action can be achieved without any disassembly of the manual grinder, this being typically a problem with known manual grinders where at least some form of disassembly is required to achieve this function. Furthermore, with the present invention the chute 46 ensures that no grindable material gets into the area in which the drive mechanism is located. The drive mechanism is thus effectively in a closed housed relative to the grindable material.

As can be seen more clearly in FIGS. 1 and 2 the split sleeve 16 when installed on the end of the shaft 14 has the frustro-conical portion 36 located in the well 19. Extending about the portion of the top of the shaft 14, which extends through the well 19 is one or, as shown, two resilient rings 50. These engage between the wall of the well 19 and the over-moulded sleeve 14a. The reason for the ring(s) 50 will hereinafter become apparent in the following description of the operation of the drive mechanism.

The tangential direction and-position (on the periphery of toothed ring 15) of the force applied to the toothed ring 15 by the rack 22 causes a relative movement to occur between the ring 15 and split sleeve 16 as the lever 11 is moved from the “rest” position of FIG. 1 to the full stroke position of FIG. 2. As a result the edge potion 43 of toothed ring 15 and projecting profile 42 of split sleeve 16 come into contact. This contact results in a deforming of the split sleeve 16 which effectively causes a reduction of the internal diameter of bore 37. This creates an immediate gripping effect (or driving contact) between split sleeve 16 and the shaft 14 (via the over-moulded sleeve 14a) to occur.

It will be appreciated by those skilled in the art that other means for providing a contact to cause contraction of bore 37 could be employed.

As a result the linear motion of rack 22 is translated into a rotary motion of toothed ring 15 such that rotation of shaft 14 takes place. This gripping or clamping effect occurs immediately the toothed ring 15 (FIG. 2) commences rotation.

Upon the lever 11 having reached the full extent of its inward movement toward the body 12, the lever 11 is released. The push element 21 thus moves under the action of springs 26 to drive 24 moves back to its “rest” position. Immediately, the return travel of the lever 11 commences the split sleeve 16 “opens” thereby releasing any grip on the shaft 14. Consequently, the combination of split sleeve 16 and toothed ring 15 rotates independently of the shaft 14.

If a pepper or peppers remain in the space between the grinding elements G and G′ the frictional effect will generally retain the shaft 14 so that it does not rotate in a reverse direction. However, when this holding effect against relative movement between the grinding element G and G′ does not exist or is slight (say if the material to be ground is a “light” material e.g. herbs) the friction to keep the grinding mechanism G/G′ and shaft 14 to rotate in a reverse direction might not exist or be sufficient. Therefore, a so-called “friction brake” is provided by the ring(s) 50 which sets up a friction in the well so as to counter any reverse rotation of the shaft 14. It will be appreciated by those skilled in the art that the frictional contact between the ring(s) 50 and the surface of the well will be greater than any frictional contact between the split sleeve 16 an over-moulded sleeve 14a in the reverse direction.

It will be appreciated by those skilled in the art that other means of applying a friction “brake” can be used. However, according to the preferred arrangement of one or more resilient rings 50 a simple neat, yet effective, friction brake is created. As a result the shaft 14 and with it the grinding mechanism G/G′ does not occur in a reverse direction even if the grinder is empty or there is few/light grinding material in the grinding mechanism.

In a preferred form of the invention the overmoulded shaft 14 is formed so as to overcome a problem that typically can arise with known condiment grinders/mills. With known designs it is not uncommon for a cavitation effect to arise as a result of rotation of the shaft within the condiment. Thus, with say peppercorns, the corns become packed in the grinder body in such a manner that the corns do not enter into the grinding mechanism. To overcome this problem the user generally needs to shake the grinder to loosen up the peppercorns so that they once again freely move into the grinder mechanism.

Because of the overmoulding the present invention permits one or more spiral flutes, grooves, recesses or the like to be formed in the overmoulding. Thus, in FIG. 15 one embodiment is shown where a pair of spiral flutes 54 are formed in the overmoulded material. Therefore as the shaft 14 rotates, the flutes 54 apply a mixing action on the condiment such that it does not cavitate or otherwise pack in the container body 12.

A further advantage is that the flutes 54 enable a user, viewing the shaft 14 through the transparent body 12, to see the shaft turning when the lever 11 is squeezed and stationary when the lever 11 is released.

In effect, therefore, the mechanism is such as to achieve a radial clamping force resulting from a linear force, which is normal to the axis of the shaft 14 and tangential to the periphery of the toothed ring 15. These clamping and release actions on the shaft 14 are achieved immediately the lever 11 commences its inward travel/outward travel. The drive is thus unidirectional. Any lost motion which may occur will be as a result of backlash of the teeth of the rack engaging the tooth ring. However, this backlash is only present when movement commences and not during the grinding action. Accordingly, a maximum degree of rotation of the shaft 14 is achieved during each movement of the lever 11 toward the body 12.

1-22. (canceled)

23. A drive mechanism including a first toothed element, a second toothed element engaged with the first toothed element, the second toothed element being movable in a first direction to cause movement of the first toothed element and in the second direction to cause reverse movement of the first toothed element, a split sleeve into a bore of which a shaft can be engaged, the split sleeve is coupled to the first toothed element such that relative movement between the split sleeve and first toothed element can occur when the second toothed element is moved in said first direction where, upon engagement, contraction of the bore creates a driving contact between the split sleeve and shaft, and said movement of the second toothed element in the second direction is in the absence of the driving contact whereby the split sleeve and first toothed element can move independent of the shaft.

24. A drive mechanism as claimed in claim 23 wherein the second toothed element is a linear toothed element.

25. A drive mechanism as claimed in claim 23 or 24 wherein the first toothed element is an annular gear element with at least part of the split sleeve located within the annular gear element and the split sleeve is pivotally coupled to the gear element.

26. A drive mechanism as claimed in claim 25 further including abutment surfaces contactable by the split sleeve to limit the amount of movement of the split sleeve relative to the annular gear element.

27. A drive mechanism as claimed in claim 25 wherein the split sleeve is pivotally coupled to the gear element about a pivot which is offset to the axis of the bore of the split sleeve.

28. A drive mechanism as claimed in claim 26 or 27 further including bias means to bias the split sleeve toward engagement of the abutment surfaces.

29. A manual grinder for the grinding of edible grindable product, the grinder including a body into which grindable product can be located for grinding by grinding elements located at an outlet end of the body, a shaft rotatably located within the body, an operating member located externally of the body, a drive mechanism according to any one of claims 23 to 28, and coupling means whereby the operating handle is coupled to the second tooth element of the drive mechanism whereby movement of the operating member will cause the second toothed element to move in the first direction and thereby cause operation of the grinding elements, there being biasing means for causing the second toothed element to move in the second direction.

30. A manual grander as claimed in claim 29 further including friction creating means which acts on the shaft when the second toothed element moves in the second direction to thereby prevent any contact between the split sleeve and the shaft causing rotation of the shaft.

31. A manual grinder as claimed in claim 29 or 30 wherein said biasing means is a pair of springs each engaged between an abutment on the second toothed element and a part of grinder.

32. A manual grinder as claimed in any one of claims 29 to 31 wherein the drive mechanism is contained within an enclosed area separate from the interior of the body in which grindable product is located.

33. A manual grinder as claimed in claim 32 wherein a chute extends through the enclosed area from an inlet and thereof and an outlet end which opens into the interior of the body.

34. A manual grinder as claimed in any one of claims 29 to 33 wherein at least a part of the shaft which locates within the body is over-moulded with one or more longitudinally extending profiled areas.
